(19) United States
(12) Patent Application Publication
(10) Pub. No.: US 2026/0356115 A1
(43) Pub. Date: Nov. 12, 2026

(54) FABRIC CORNER BOOKMARK WITH A POCKET AND A PEN HOLDER

(71) Applicant: Maria Beaujean, Cypress, TX (US)

(72) Inventor: Maria Beaujean, Cypress, TX (US)

(21) Appl. No.: 19/672,546

(22) Filed: May 8, 2026

Related U.S. Application Data
(60) Provisional application No. 63/802,817, filed on May 9, 2025.

(51) Int. Cl. B42D 9/00

(52) U.S. Cl. CPC B42D 9/005

(57) ABSTRACT

A fabric corner bookmark formed of two overlapping rectangular fabric panels secured together at their upper ends and laterally opposed sides and open at their bottom ends to form a storage pocket for receiving miscellaneous items, and a right angle triangularly shaped fabric panel having two sides secured to the upper end and one side of the storage pocket, respectively, and open on the hypotenuse side adapted to be removably placed on the corner of a page or the cover of a book. The bookmark may also have a tubular fabric sheath on an outer side for holding a pen, pencil, or other item.

### CROSS-REFERENCE TO RELATED APPLICATIONS

This application claims priority of U.S. provisional application Ser. No. 63/802,817 filed on May 9, 2025

### FIELD

The present invention relates generally to bookmarks, and, more particularly to a fabric corner bookmark

### BACKGROUND

There are several patents and publications directed toward triangular bookmarks. While various bookmark designs exist, there remains a continuing need for an improved bookmark that securely holds reading accessories and miscellaneous items without easily detaching from the book or page.

### SUMMARY

In one aspect of the present invention, a fabric corner bookmark is provided. The fabric corner bookmark includes two overlapping rectangular fabric panels secured together at their upper ends and laterally opposed sides and open at their bottom ends to form a storage pocket for receiving miscellaneous items. The fabric corner bookmark further includes a right angle triangularly shaped fabric panel having two sides secured to the upper end and one side of the storage pocket, respectively, and open on the hypotenuse side to be removably placed on the corner of a page or the cover of a book.

In another aspect of the present invention, a fabric corner bookmark is provided. The fabric bookmark includes at least one rectangular panel, and a right angle triangularly shaped fabric panel having two sides secured to the upper end and one side of the at least one rectangular panel, respectively, and open on the hypotenuse side to be removably placed on the corner of a page or the cover of a book. The fabric corner bookmark further includes a tubular fabric sheath on an outer side of the at least one rectangular panel for holding a pen, pencil, or other item.

In still another aspect of the present invention, an apparatus is provided. The apparatus includes a fabric corner bookmark. The fabric corner bookmark includes at least a first rectangular panel, a right angle triangularly shaped fabric panel having two sides secured to the upper end and one side of the first rectangular panel, respectively, and open on the hypotenuse side to be removably placed on the corner of a page or the cover of a book. The fabric corner bookmarks further includes a tubular fabric sheath on an outer side of the first rectangular panel. The apparatus also includes an item held by the sheath.

### BRIEF DESCRIPTION OF THE DRAWINGS

FIG. 1 is an orthogonal view shown from the front and bottom end of the fabric corner bookmark in accordance with the present invention with the storage pocket for holding miscellaneous items in a closed position.

FIG. 2 is an orthogonal view shown from the front and bottom end of the fabric corner bookmark in accordance with the present invention with the storage pocket open for holding miscellaneous items.

FIG. 3 is a perspective view showing the fabric corner bookmark in accordance with the present invention removably supported on the corner of the cover of a book and a pen removably supported in the tubular fabric sheath.

FIG. 4 is an orthogonal view shown from the front and bottom end of the fabric corner bookmark in accordance with the present invention and a short chain fob having a D-shaped carabiner clip at one end and an ornament at the opposed end prior to attachment to the tubular fabric sheath.

FIG. 5 is an orthogonal view shown from the front and bottom end of the fabric corner bookmark in accordance with the present invention shown with the D-shaped carabiner clip of the short chain fob attached to the tubular fabric sheath.

FIG. 6 is a perspective view showing the fabric corner bookmark in accordance with the present invention removably supported on the corner of a right-hand page of an open book to display indicia on an outward-facing side of a rectangular fabric panel

### DETAILED DESCRIPTION

The present application is directed to a fabric corner bookmark formed of two overlapping rectangular fabric panels sewn together at their upper ends and laterally opposed sides and open at their bottom ends to form a storage pocket for receiving miscellaneous items, fastener means adjacent to the bottom ends of the fabric panels for retaining the miscellaneous items, and a right angle triangularly shaped fabric panel having two sides sewn to the upper end and one side of the storage pocket, respectively, and open on the hypotenuse side adapted to be removably placed on the corner of a page or the cover of a book. The bookmark may also have a tubular fabric sheath on an outer side for holding a pen, pencil, or other item.

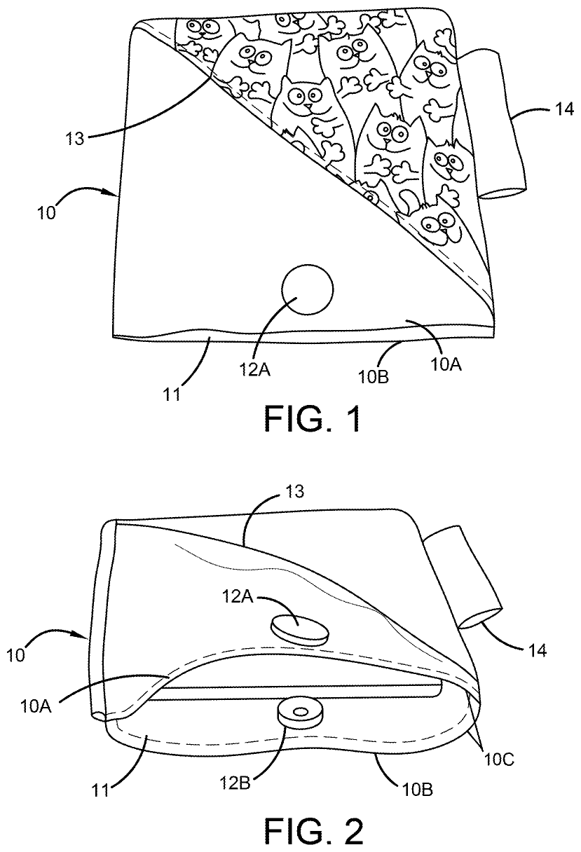

Referring to the drawings by numerals of reference, there is shown in FIGS. 1-5, a preferred fabric corner bookmark 10 formed of two overlapping rectangular fabric panels 10A and 10B sewn together at their upper ends and laterally opposed sides and open at their bottom ends 10C to form a storage pocket 11 for receiving and holding miscellaneous items.

A pair of mating fastener members 12A and 12B are secured means adjacent to the bottom ends of the fabric panels 10A and 10B for retaining the miscellaneous items,

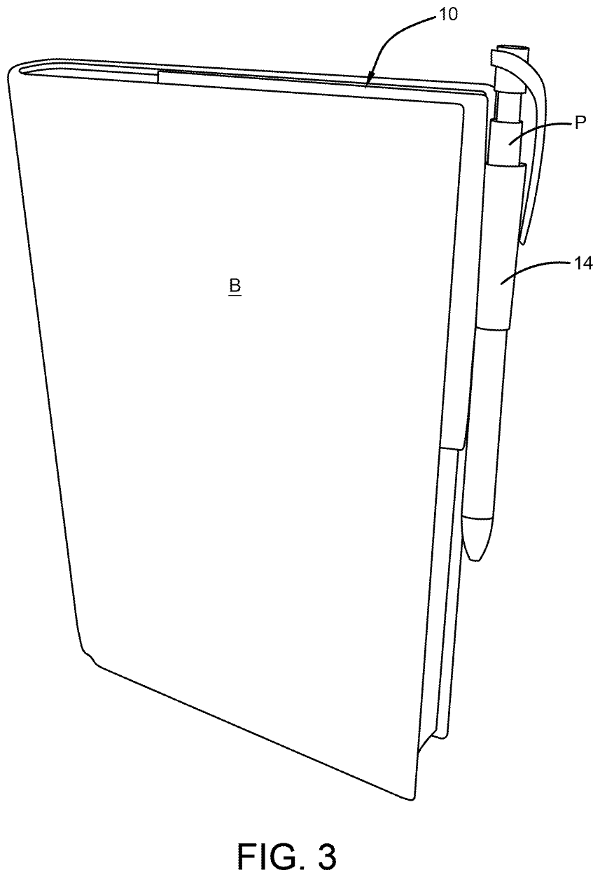

A right angle triangularly shaped fabric panel 13 having two sides is sewn to the upper end and one side of the storage pocket 11, respectively, and is open on the hypotenuse side. The triangularly shaped fabric panel 13 is adapted to be removably placed on the corner of a page or the cover of a book B as shown in FIG. 3.

The fabric corner bookmark 10 may also be provided with a tubular fabric sheath 14 on an outer side for removably receiving and holding a pencil or pen P, or other item.

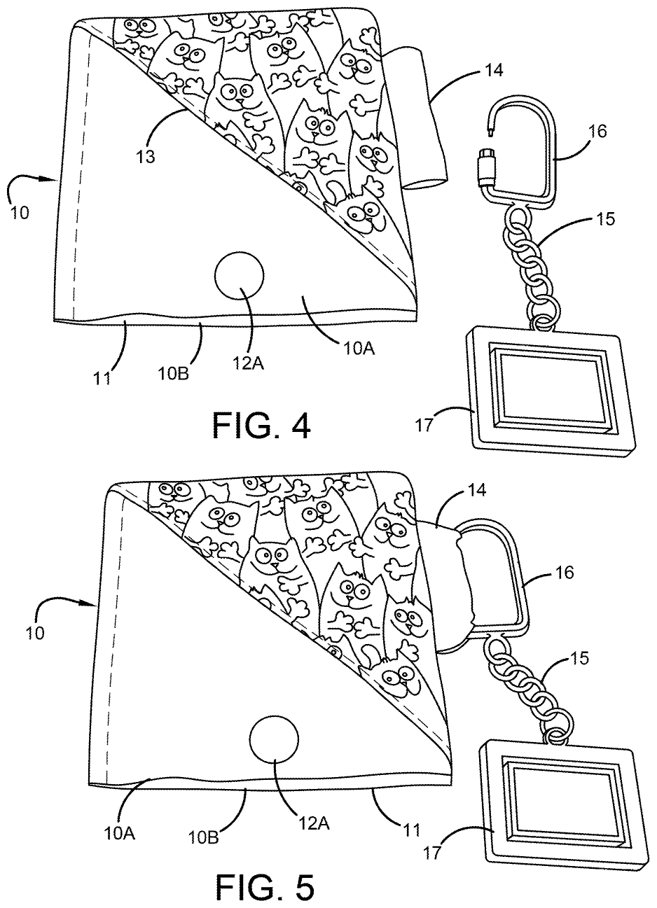

For example, as shown in FIGS. 4 and 5, the tubular fabric sheath 14 is also adapted to receive a short chain fob 15 having a D-shaped carabiner clip 16 at one end and an ornament 17 or other object at the opposed end, such as a set of keys (not shown).

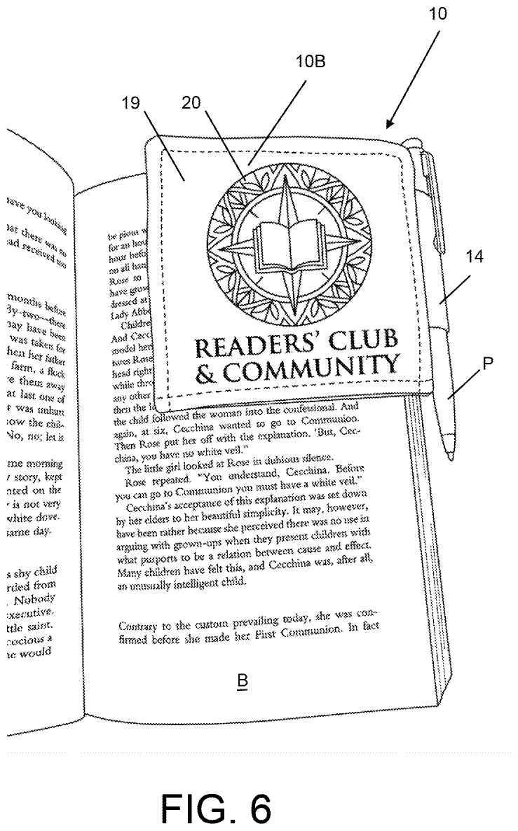

In one or more embodiments, the outer surface of at least one of the fabric panels may further comprise decorative or informational indicia. For example, as illustrated in FIG. 6, the outward-facing side 19 of the fabric panel 10B may include printed, embroidered, or otherwise affixed logos, text, slogans, or images or other suitable indicia 20. Furthermore, the fabric corner bookmark is reversible in its application. As illustrated in FIG. 6, when installed on the upper right corner of a right-hand page of an open book B, the bookmark 10 may be oriented such that the outer side 19 of the rectangular fabric panel 10B (displaying a logo or other indicia) faces the reader, while the triangularly shaped fabric panel 13 is positioned behind the page of the book B. This reversible configuration allows the user to prominently display either side of the bookmark 10 while maintaining full functionality of the tubular fabric sheath 14.

Advantageously, the fabric corner bookmark is a highly versatile, multi-functional accessory. In various implementations, the bookmark is configured for use as a traditional corner page marker, a meeting binder tab, or a protective coaster. Furthermore, the specific structural elements of the device provide additional utility. For example, the tubular fabric sheath is adapted to function as a holder for a writing utensil or a keychain, while the storage pocket is configured to securely retain notes or other miscellaneous items. Additionally, the overall assembly may be utilized as a decorative item, such as a holiday or Christmas ornament.

As used herein, the term ‘secured’ includes being sewn together. While the components of the bookmark are primarily described and shown as being sewn, it should be understood by one of ordinary skill in the art that the panels may alternatively be secured using adhesives, thermal bonding, sonic welding, or other suitable manufacturing methods.

While the present invention has been disclosed in various preferred forms, the specific embodiments thereof as disclosed and illustrated herein are considered as illustrative only of the principles of the invention and are not to be considered in a limiting sense in interpreting the claims. The claims are intended to include all novel and non-obvious combinations and sub-combinations of the various elements, features, functions, and/or properties disclosed herein. Variations in size, materials, shape, form, function and manner of operation, assembly and use, are deemed readily apparent and obvious to one skilled in the art from this disclosure, and all equivalent relationships to those illustrated in the drawings and described in the specification are intended to be encompassed in the following claims defining the present invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above-described embodiments, but by all embodiments and methods within the scope and spirit of the invention.

What is claimed is:

1. A fabric corner bookmark comprising:
two overlapping rectangular fabric panels secured together at their upper ends and laterally opposed sides and open at their bottom ends to form a storage pocket for receiving miscellaneous items; and
a right angle triangularly shaped fabric panel having two sides secured to the upper end and one side of the storage pocket, respectively, and open on the hypotenuse side to be removably placed on the corner of a page or the cover of a book.

2. The fabric corner bookmark according to claim 1, wherein the two overlapping rectangular fabric panels are sewn together, and wherein the two sides of the right angle triangularly shaped fabric panel are sewn to the storage pocket.

3. The fabric corner bookmark according to claim 1, further comprising:
a tubular fabric sheath on an outer side of the fabric corner bookmark for holding a pen, pencil, or other item.

4. The fabric corner bookmark according to claim 3, wherein the two overlapping rectangular fabric panels are sewn together, and wherein the two sides of the right angle triangularly shaped fabric panel are sewn to the storage pocket.

5. The fabric corner bookmark according to claim 3, wherein the tubular fabric sheath is configured to receive a D-shaped carabiner clip of a chain fob.

6. The fabric corner bookmark according to claim 1, further comprising a fastener arrangement operatively associated with the bottom ends of the fabric panels for releasably retaining the miscellaneous items in the storage pocket.

7. The fabric corner bookmark according to claim 6, wherein the fastener arrangement comprises a pair of mating fastener members.

8. A fabric corner bookmark comprising:
at least one rectangular panel;
a right angle triangularly shaped fabric panel having two sides secured to the upper end and one side of the at least one rectangular panel, respectively, and open on the hypotenuse side to be removably placed on the corner of a page or the cover of a book; and
a tubular fabric sheath on an outer side of the fabric corner bookmark for holding a pen, pencil, or other item.

9. The fabric corner bookmark according to claim 8, wherein the at least one rectangular panel comprises a fabric panel having decorative or informational indicia disposed on an outer side thereof.

10. The fabric corner bookmark according to claim 8, wherein the two sides of the right angle triangularly shaped fabric panel are sewn to the at least one rectangular panel.

11. An apparatus comprising:
a fabric corner bookmark comprising:
at least a first rectangular panel;
a right angle triangularly shaped fabric panel having two sides secured to the upper end and one side of the first rectangular panel, respectively, and open on the hypotenuse side to be removably placed on the corner of a page or the cover of a book;
a tubular fabric sheath on an outer side of the first rectangular panel; and
an item held by the sheath.

12. The apparatus according to claim 11, wherein the two sides of the right angle triangularly shaped fabric panel are sewn to the first rectangular panel.

13. The apparatus of claim 11, further comprising a second rectangular panel, wherein the first and second rectangular panels overlap each other and are secured together at their upper ends and laterally opposed sides and open at their bottom ends to form a storage pocket for receiving miscellaneous other items.

14. The apparatus according to claim 13, wherein the first and second overlapping rectangular fabric panels are sewn together, and wherein the two sides of the right angle triangularly shaped fabric panel are sewn to the storage pocket.

15. The apparatus according to claim 11, wherein the item comprises a pencil or pen.

16. The apparatus of claim 15, further comprising a second rectangular panel, wherein the first and second rectangular panels overlap each other and are secured together at their upper ends and laterally opposed sides and open at their bottom ends to form a storage pocket for receiving miscellaneous other items.

17. The apparatus according to claim 11, wherein the item comprises a chain fob, wherein the chain fob comprises a D-shaped carabiner clip at a first end, wherein the sheath receives the carabiner clip.

18. The apparatus of claim 17, wherein the chain fob comprises an ornament at an opposed, with respect to the first end, second end of the chain fob.

19. The apparatus of claim 18, further comprising a second rectangular panel, wherein the first and second rectangular panels overlap each other and are secured together at their upper ends and laterally opposed sides and open at their bottom ends to form a storage pocket for receiving miscellaneous other items.

20. The apparatus according to claim 19, wherein the two overlapping rectangular fabric panels are sewn together, and wherein the two sides of the right angle triangularly shaped fabric panel are sewn to the storage pocket.
